(19) United States
(12) Patent Application Publication
(10) Pub. No.: US 2026/0210012 A1
(43) Pub. Date: Jul. 23, 2026

(54) TEXTILE ASSEMBLIES AND METHODS OF FORMING TEXTILE ASSEMBLIES WITH EMBEDDED POLYMER FEATURES

(71) Applicant: Studio KMD LLC, Albion, NY (US)

(72) Inventors: Bryce BEAMER, Albion, NY (US); John David STACK, Ballston Spa, NY (US)

(21) Appl. No.: 19/105,960

(22) PCT Filed: Aug. 25, 2023
(86) PCT No.: PCT/US2023/031149

§ 371 Date: Feb. 24, 2025

Related U.S. Application Data
(60) Provisional application No. 63/400,967, filed on Aug. 25, 2022.
(60) Provisional application No. 63/411,237, filed on Sep. 29, 2022.

(51) Int. Cl. D06C 23/00; B32B 3/08; B32B 5/02; B32B 5/26; B33Y 80/00; F15B 15/20; F21V 33/00; F21Y 103/10; F21Y 115/10

(52) U.S. Cl. CPC D06C 23/00; B32B 3/08; B32B 5/02; B32B 5/26; B33Y 80/00; F21V 33/0008; B32B 2250/20; B32B 2437/00; B32B 2437/02; F15B 15/20; F21Y 2103/10; F21Y 2115/10

(57) ABSTRACT

Methods for embedding technology, electronics or functional materials into single or multilayer textile structures using thermoplastic channels, pegs, slots or other routing or supporting geometry. The resulting textile structures could be used to enhance textile performance, create anisotropic or tunable textile performance, create pathways for gasses, fluids, wires, conductive materials, hoses, tubing, fibers, sensors and actuators.

### BACKGROUND

### Field of the Invention

Embodiments of textile assemblies and methods of forming textile assemblies with embedded polymer features are described herein.

### Description of the Related Art

Functional performance attributes of textiles may include flexibility, permeability, stretch, and tensile strength. Although textiles may have certain performance attributes for certain applications, often complexities are encountered in processing and integrating the textiles with other materials that may have conflicting performance attributes to those of the textiles.

Some efforts have been made to take advantage of textile performance in mechanical applications. In some instances, this has involved the creation of monolithic textile composites in which some performance attributes of the textile were amplified, and others were suppressed or eliminated.

Thus, there is a need for techniques and systems for integrating features into textiles and films that at least maintain and possibly enhance functional performance attributes of textiles or films. Also, there is a need for a robust and efficient system for integration of new technologies or materials into textile structures or vice versa. There are numerous product opportunities where these attributes can be used including, but not limited, to connected apparel, wearable electronics, robotics, lighting, optical displays, footwear, assistive devices, filters, healthcare and safety products.

### SUMMARY

Embodiments of textile assemblies and methods of forming textile assemblies are described herein. In some embodiments, methods of forming a textile assemblies may include forming a first plurality of polymer features by disposing a first polymer on a first textile; routing one or more elongate elements between the first plurality of polymer features; and encapsulating the one or more elongate elements and at least some of the first plurality of polymer features with a second textile layer or a second polymer feature.

In some embodiments, a textile assembly may include a first textile; a first plurality of polymer features made from a first polymer disposed on a first textile; one or more elongate elements routed between the first plurality of polymer features; and a second textile layer or a second polymer feature that encapsulates the one or more elongate elements and at least some of the first plurality of polymer features.

In some embodiments, A multi-layered textile assembly may include a plurality of textile assemblies stacked on top of each other, wherein each textile assembly includes: a first textile; a first plurality of polymer features made from a first polymer disposed on a first textile; one or more elongate elements routed between the first plurality of polymer features; and an encapsulation layer that encapsulates the one or more elongate elements and at least some of the first plurality of polymer features.

At least some of the embodiments of the present invention satisfy the above needs while offering a variety of other functional benefits, which are made apparent through the descriptions and figures attached.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1A-1D show a method of forming a textile assembly according to some embodiments of the present disclosure.

FIG. 2 shows a method of forming a textile assembly according to some embodiments of the present disclosure.

FIG. 3 shows a method of forming a textile assembly according to some embodiments of the present disclosure.

FIGS. 4A-4C show a method of forming a textile assembly according to some embodiments of the present disclosure.

FIGS. 5A-5C show a plan view of textile assemblies according to some embodiments of the present disclosure.

FIG. 5D shows the textile assembly of FIG. 5C used on a garment according to some embodiments of the present disclosure.

FIG. 5E shows a cross section of the garment in FIG. 5D along line 5E-5E in FIG. 5D.

FIG. 6 shows a plan view of a textile assembly according to some embodiments of the present disclosure.

FIGS. 7A-7E show a plan view of textile assemblies according to some embodiments of the present disclosure.

FIGS. 8A-8C show footwear incorporating textile assemblies according to some embodiments of the present disclosure.

FIGS. 9A-9L show various profiles of guides according to some embodiments of the present disclosure.

FIGS. 10A-10B show a cross section of a textile assembly according to some embodiments of the present disclosure.

FIGS. 11A-11D show a method of forming a textile assembly according to some embodiments of the present disclosure.

FIGS. 12A-12D show a method of forming a textile assembly according to some embodiments of the present disclosure.

FIGS. 13A-13E show a method of forming a textile assembly according to some embodiments of the present disclosure.

FIGS. 14A-14C show stacked textile assemblies according to some embodiments of the present disclosure.

FIGS. 15A-15C show a method of forming a textile assembly according to some embodiments of the present disclosure.

FIG. 15D-15I show a method of forming a textile assembly according to some embodiments of the present disclosure.

FIG. 16 shows a method of forming a textile assembly according to some embodiments of the present disclosure.

FIG. 17A shows a method of forming a textile assembly according to some embodiments of the present disclosure.

FIGS. 17B-17E shows a method of forming a textile assembly according to some embodiments of the present disclosure.

FIGS. 18A-18B show methods of forming a textile assembly according to some embodiments of the present disclosure.

FIGS. 19A-19B show a method of forming a textile assembly according to some embodiments of the present disclosure.

FIGS. 19C-19E show a method of forming a textile assembly according to some embodiments of the present disclosure.

FIGS. 20A-20D show cross sections of textile assemblies that include strip lighting components according to some embodiments of the present disclosure.

FIG. 21A shows a plan view of a textile assembly that includes singulated lighting components according to some embodiments of the present disclosure.

FIG. 21B shows a cross section of the textile assembly in FIG. 21A along line 21B-21B in FIG. 21A.

FIGS. 22A-22C show textile assemblies that include fiber optics according to some embodiments of the present disclosure.

FIGS. 23A-23C show cross sections of textile assemblies including pneumatics or hydraulics according to some embodiments of the present disclosure.

FIG. 24 shows a plan view of a textile assembly according to some embodiments of the present disclosure.

FIG. 25 shows a plan view of a textile assembly according to some embodiments of the present disclosure.

FIG. 26A shows a plan view of a textile assembly including a bladder according to some embodiments of the present disclosure.

FIG. 26B shows a side view of the textile assembly shown in FIG. 26A in an uninflated configuration.

FIG. 26C shows a side view of the textile assembly shown in FIG. 26A in an inflated configuration.

FIG. 27A shows stacked textile assemblies shown in FIG. 26A in an uninflated configuration.

FIG. 27B shows stacked textile assemblies shown in FIG. 26A in an inflated configuration.

FIG. 28A shows a plan view of a textile assembly arranged for fluid flow according to some embodiments of the present disclosure.

FIG. 28B shows a plan view of an alternative embodiment of the textile assembly to that shown in FIG. 28A with a cover removed for clarity of illustration.

FIG. 28C shows a cover of the textile assembly shown in FIG. 28C.

FIG. 28D shows a cross section of the textile assembly shown in FIG. 28C along line section 28C-28C in FIG. 28C.

FIGS. 29A and 29B show a textile assembly in accordance with some embodiments of the present disclosure.

FIG. 29C shows a textile assembly configured for articulation according to some embodiments of the present disclosure.

FIG. 29D shows a cross section of the textile assembly shown in FIG. 29C along line 29D-29D in FIG. 29C.

FIG. 29E is a side elevation view of the textile assembly shown in FIG. 29C in a first configuration.

FIG. 29F shows the textile assembly in FIG. 29E in a second configuration.

FIG. 29G shows a textile assembly in accordance with some embodiments of the present disclosure.

FIGS. 30A-30B show an alternative embodiment of the textile assembly shown in FIGS. 29C-29F.

FIGS. 31A-31B show a textile assembly according to some embodiments of the present disclosure.

FIGS. 32A-32B show a textile assembly according to some embodiments of the present disclosure.

FIGS. 33A-33D show a textile assembly according to some embodiments of the present disclosure.

FIG. 34A shows a plan view of a textile assembly according to some embodiments of the present disclosure.

FIG. 34B shows a cross section of a textile assembly shown in FIG. 34A along section 34B-34B in FIG. 34A.

FIG. 34C shows a cross section of the textile assembly shown in FIG. 34A along section 34C-34C in FIG. 34A.

To facilitate understanding, identical reference numerals have been used, where possible, to designate identical elements that are common to the figures. The figures are not drawn to scale and may be simplified for clarity. Elements and features of one embodiment may be beneficially incorporated in other embodiments without further recitation.

### DETAILED DESCRIPTION

Embodiments of textile assemblies and methods of forming textile assemblies are described herein. The methods and devices described herein are related to structures embedded into textile and film structures, and more particularly, to combining cast, printed, or molded features with textile or film structures to enhance performance or introduce new functionality to the textile or film structures. In some embodiments described herein, the features may include guides for routing or containing solids or fluids (e.g., liquids or gases). In some embodiments, guides may be used to route subcomponents between them. In some embodiments, the subcomponents may be elongate elements (wires, cables, lighting strips, tension cables) routed between the guides. In some embodiments, the guides, when encapsulated, may route fluids, such as air, hydraulic fluid, or heat transfer fluids. That is, in some embodiments, the fluids are the subcomponents being routed between the guides. In some embodiments, guides may contain, encapsulate, or protect subcomponents/objects such as sensor electronics or other components. In some embodiments, the guides may be formed as at least one of a grid of pegs, rows of elongated or segmented walls, or a cavity. In some embodiments described herein, the features may include polymers encapsulating portions (e.g., fibers) of a textile or film. In some embodiments, the encapsulated features may be used as attachment points for attaching other structures to the textile or film.

In some embodiments, methods of forming a textile assembly may include forming a polymer feature from a liquid or molten polymer while bonding the polymer feature to a textile. In some embodiments, the methods of forming a textile may be adapted for various production scales. There are numerous methods for producing the features described herein and the production method may vary based on production volume or performance attributes making the approach adaptable to small scale prototyping and mass production. For example, in some embodiments, the methods of forming a textile composite may include forming the polymer features by at least one of 3D printing, molding, casting, inkjet printing, CNC deposition, lamination, die cutting, or screen printing.

As used herein, “textile” and “film” may be used interchangeably to refer to substrate material or superstrate that functions as a flexible plane. Examples of these materials are knits, wovens, non-wovens, extruded films, blown films, which can be formed from various types of yarns, include natural and high-performance yarns. The materials may have traditional textile structures, such as jersey knits or plain weaves, or more complex structures including but not limited to 3D spacer meshes, warp knits, or leno weaves. These materials may also go through secondary processing such as die cutting, texturing, foaming, flocking, laser cutting, die cutting or burnouts to change performance, appearance, or to provide variability in texture, or 3D volume.

As used herein, “polymer” or “liquid polymer” may be used to refer to any thermoset, or thermoplastic polymer or other material that can be modified to become liquid or have a viscosity change through heating, chemical reaction, or dissolved in solution.

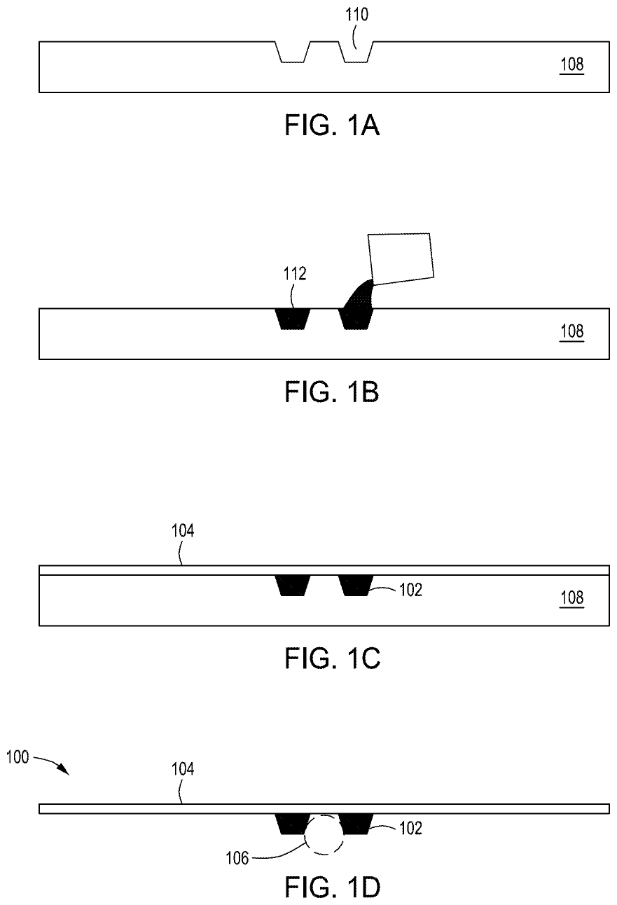

FIGS. 1A-1D show a method of forming a textile assembly 100 including a feature 102 and a textile 104 in accordance with some embodiments of the present disclosure. As used herein, textile and film are used interchangeably. In some embodiments, the features 102 may be guides, which may be formed from a polymer (e.g., thermoplastic or thermoset). In some embodiments, the guides 102 described herein may be used for routing or embedding objects to be coupled to the textile assembly 100. In some embodiments, and as shown in FIG. 1D, the guides 102 may be used for routing elongate elements 106, including rope, wire, yarn, cable, tubes, fiber optic or other strand-or strip-based technology, but can also be customized to have encapsulating geometry that can be used for specific inserts, including but not limited to PCB, conductive fabric, shielding, sensors and actuators.

There are numerous methods of combining features with a textile based on the geometric needs and production volumes. In some embodiments, and as shown in FIG. 1A, a casting mold 108 is provided having grooves 110 for receiving a liquid polymer. The grooves 110 have a shape corresponding to the desired profile shape of the features 102 to be connected to the textile 104. In FIG. 1B, a liquid polymer is introduced into the grooves 110 of the casting mold 108. The liquid polymer in the casting mold 108 forms polymer guides 102. In FIG. 1C a textile 104 is placed over the casting mold 108 in contact with the liquid polymer in the grooves 110. Once the liquid polymer solidifies and forms guides 102, the guides 102 remain attached to the textile 104 forming the textile assembly 100 when the casting mold 108 is separated from the textile 104. Thus, in the embodiment shown in FIGS. 1A-1D, the guides 102 may be formed while being bonded to the textile 104.

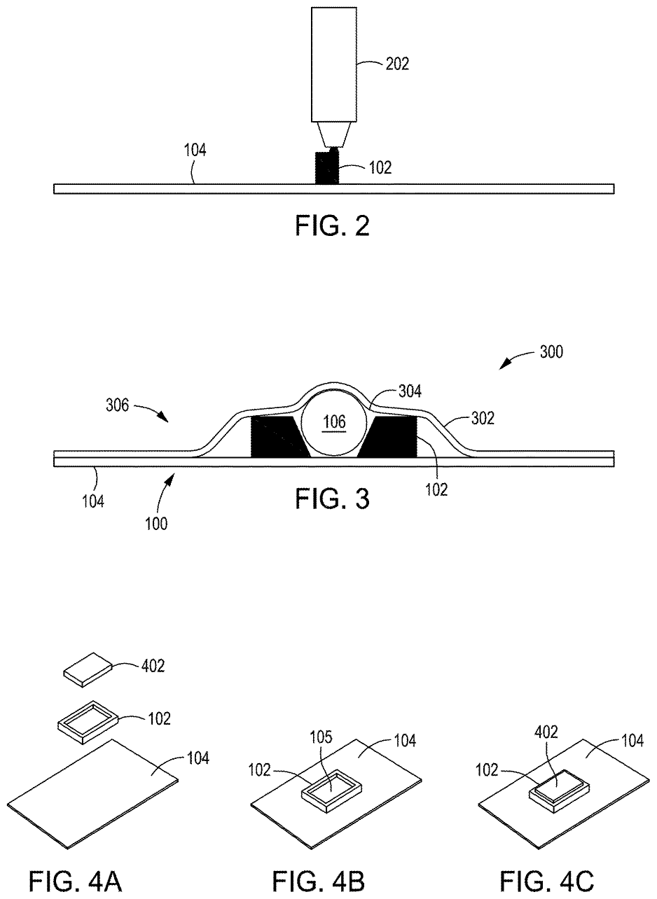

FIG. 2 shows another embodiment of forming the textile assembly 100. In some embodiments, and as shown in FIG. 2, a feature 102 (e.g., polymer guide) is 3D printed directly on the textile 104 using a 3D print nozzle 202 attached to a 3D printer. In some embodiments, and as shown in FIG. 2, the feature 102 may be deposited as a liquid directly on the textile 104 so that the feature 102 may be formed while being bonded to the textile. Upon solidification of the feature 102, the feature 102 remains connected to the textile 104 forming the textile assembly 100.

FIG. 3 shows a cross-section of a textile assembly 300 in accordance with some embodiments of the present disclosure. In some embodiments, and as shown in FIG. 3, the textile assembly 300 may include the same constructions as the textile assembly 100, along with another textile layer 302 and a subcomponent such as an elongate element 106 (e.g., rope, string, cable, tube, etc.) disposed between the textile 104 and the textile layer 302. In some embodiments, and as shown in FIG. 3, the guides 102 are attached (e.g., bonded) to the textile 104 and route the elongate element 106 between the layers of textiles 104 and 302 along on a certain pathway, further details of which are described herein below. In some embodiments, the textile layer 302 may also be attached (e.g., bonded) to the guides 102. In some embodiments, and as shown in FIG. 3, the layers of textiles 104 and 302 may be bonded or laminated together in one or more areas adjacent to the guides 102 to secure the elongate element 106 in a space 304 between the guides 102 and the layers of textiles 104 and 302 as an assembly 306, which may be integrated into a larger assembly (e.g., an article of clothing). Such larger assembly may be a flexible or rigid structure.

In some embodiments, and as shown in FIGS. 4A-4C, the shape of the guides 102 may be varied to allow for the encapsulation of a variety of objects 402, which may include electronics, boning, stiffening members, or other functional inserts. In FIGS. 4A-4C, guides 102 are attached to a textile 104 to form a cavity 105 to accommodate an object 402, which may be an electronic module. Another textile layer (not shown) may be placed over the object 402 and the guides 102 to cover the guides 102 and the object 402 and bond to at least one of the textile 104, the guides 102, or the object 402 to thereby secure the module in the cavity 105. In some embodiments, the object 402 may be covered by depositing additional polymer material over the object and the guides.

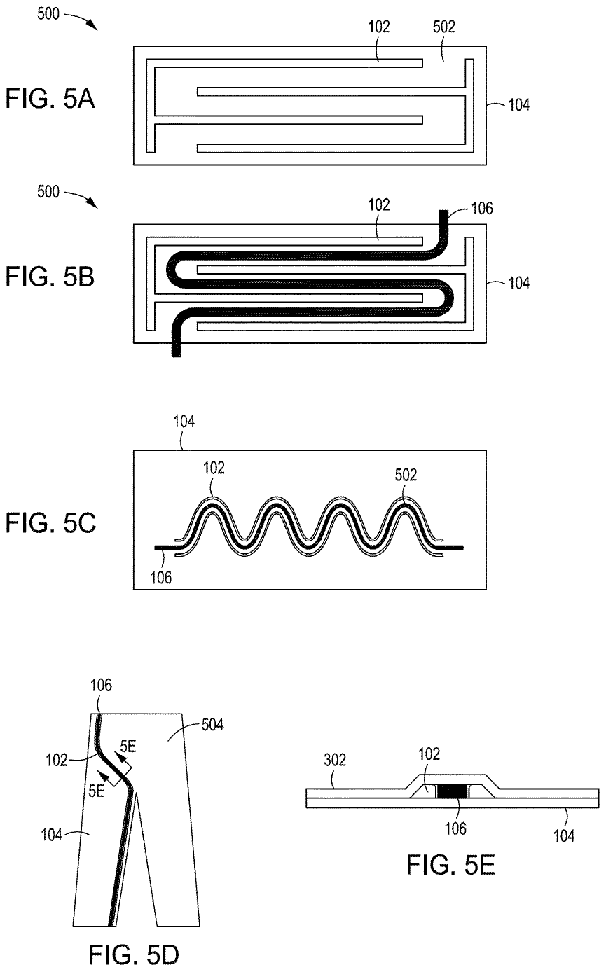

Guides 102 may be arranged to form various routing geometries based on the intended application. FIGS. 5A-5B show textile assemblies 500 that include elongated guides 102 attached to the textile 104 where the guides 102 are arranged to form a maze or zig-zag routing pathway 502 for the elongate element 106. The zig-zag pathway 502 may provide systematic coverage over a defined zone of the textile 104.

In some embodiments, and as shown in FIG. 5C, the routing pathway 502 may be sinusoidal, which may be used for routing between two points, potentially with integrated functional geometry, and which may be used to help reduce perceptibility of a cable in a garment 504 (FIG. 5D) by avoiding areas of high strain or distortion. As shown with the textile assembly 300 shown in FIG. 3, the textile assembly 500 may include a textile layer 302 that covers over the guides 102 and the elongate element 106 and that is bonded to at least one of the textile 104, the elongate element, or the guides 102 along the length of the elongate element 106.

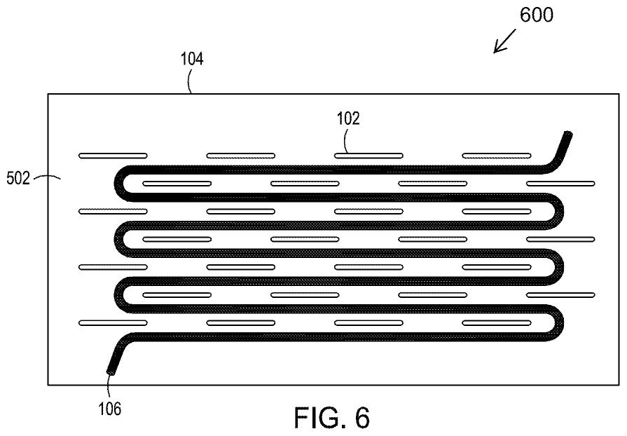

The textile assemblies 500 shown in FIGS. 5A and 5B may be modified by segmenting the elongated guides 102 as shown in the embodiment of the textile assembly 600 shown in FIG. 6. The segmented guides 102 may allow for a repeat or patterned deposition of guides 102 that may contribute to aesthetic and functional needs of a part, such as improved flexibility and stretch in the routing pathway 502 compared to the embodiments shown in FIGS. 5A and 5B that use solid guides 102. The routing pathway 502 shown in FIG. 6 may also allow for improved customization, strain relief, over-feeding and alternate cable management approaches compared to the routing pathway 502 shown in FIGS. 5A and 5B that use solid guides 102.

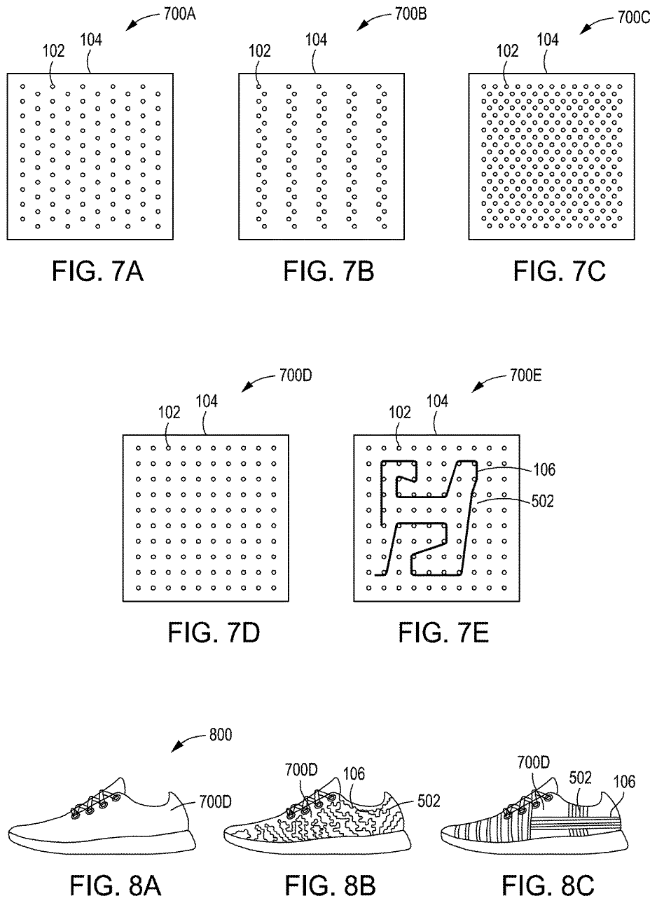

FIGS. 7A-7E show textile assemblies 700A-700E in accordance with some embodiments of the present disclosure. The textile assemblies 700A-700E may be further modifications of the textile assembly 600 in which the elongated segmented guides 102 are formed as discrete peg guides arranged in various patterns or grids. As shown in FIG. 7E, the elongate element 106 may be routed along a routing pathway 502 between the peg guides 102. Use of pegs guides 102 may allow for customization of routing pathways 502 while maintaining a standardized layout of the guides 102. For example, the peg guides 102 may be equally spaced from one another in a regular grid as shown in FIGS. 7A, 7C, 7D and 7E allowing for multiple custom routing pathways 502. This could be beneficial for mass customization without additional tooling or production complexity. The textile assemblies 700A-700E may be useful for applications that require tensile reinforcement, strain relief, zonal heating, etc.

FIGS. 8A-8D show examples of footwear that may include a textile assembly, such as textile assembly 700D, that has a regular grid of peg guides 102. As shown in FIGS. 8B and 8C, different routing pathways 502 for the elongate element 106 are defined using the same regular grid of peg guides 102 on the footwear.

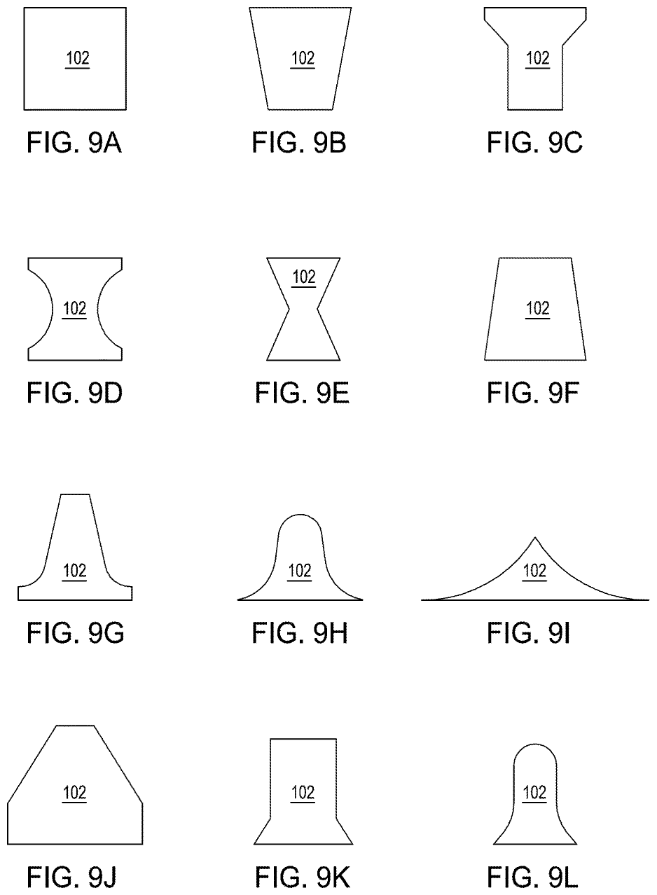

FIGS. 9A-9L show various profile shapes of guides 102 in accordance with some embodiments of the disclosure. The guides 102 may have various profiles to alter the functional performance of the textile assemblies described herein. For example, customizing the profiles of guides 102 can change performance characteristics, such as tuning sensor output, improving assembly alignment or other characteristics. The guides 102 may have various profiles to facilitate manufacturing.

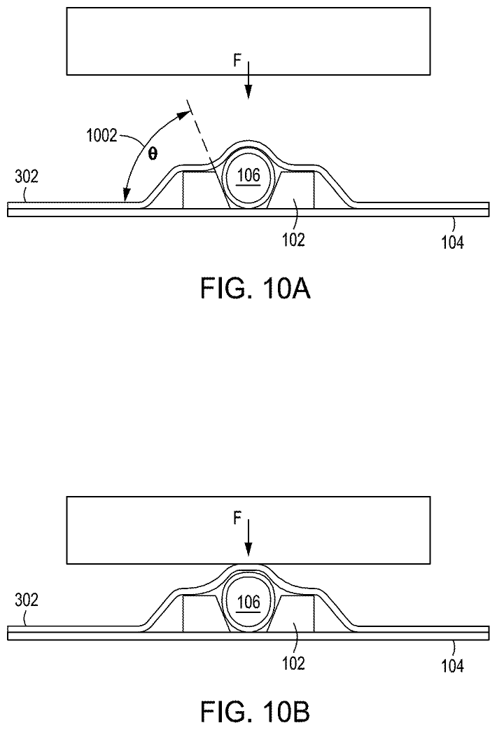

In some embodiments, and as shown in FIGS. 10A and 10B, the elongate element 106 may be a tube carrying a fluid (e.g., gas or liquid). The tube 106 may be connected to a pressure sensing element (not shown). The tube 106, fluid, sensing element, and the guides 102 may be arranged as a sensor to sense pressure changes of the fluid in the tube 106. The pressure may change due to compression of the tube 106, such as by an application of an external force on the tube 106, as shown in FIG. 10B. Variations in mechanical performance of the guides 102 may be used to influence the compression volume of the tube 106 to tune the sensitivity of the sensor/textile assembly. For example, the profile and/or material properties of the guides 102 may be changed to influence the deformation of the textile assembly under a given force enabling tuning of the tube 106 pressure to a targeted value or range. In some embodiments shown in FIGS. 10A and 10B, an angle 1002 of the guides 102 may influence the deformation of the tube 106, which may change the pressure response curve. Other methods for tuning include, but are not limited to, changes in durometer, height, width or the ratio between dimensions of the guides 102 and the tube 106

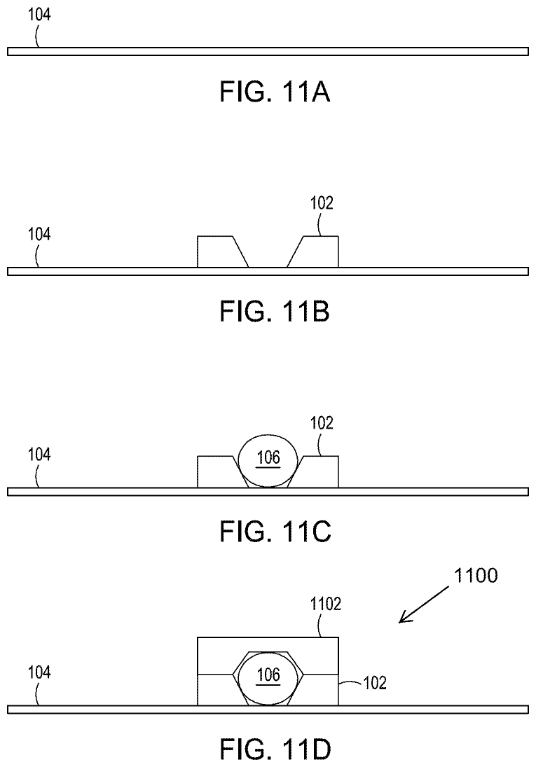

FIGS. 11A-11D show a method of forming a textile assembly 1100 in accordance with some embodiments of the present disclosure. In some embodiments, and as shown in FIG. 11A, a textile 104 may be provided. As shown in FIG. 11B, guides 102 are deposited or otherwise formed on the textile 104 as described above. In some embodiments, and as shown in FIG. 11C, an elongate element 106 may be introduced between the guides 102. As shown in FIG. 11D, a guide 1102 may be deposited onto a top of the guides 102 to secure the elongate element 106 in place without needing a second textile layer. The method shown in FIGS. 11A-11D may be useful in applications where an additional textile layer, such as textile layer 302, would not be ideal or when visual inspection or access to the routing pathway 502 could be beneficial for functional or aesthetic purposes.

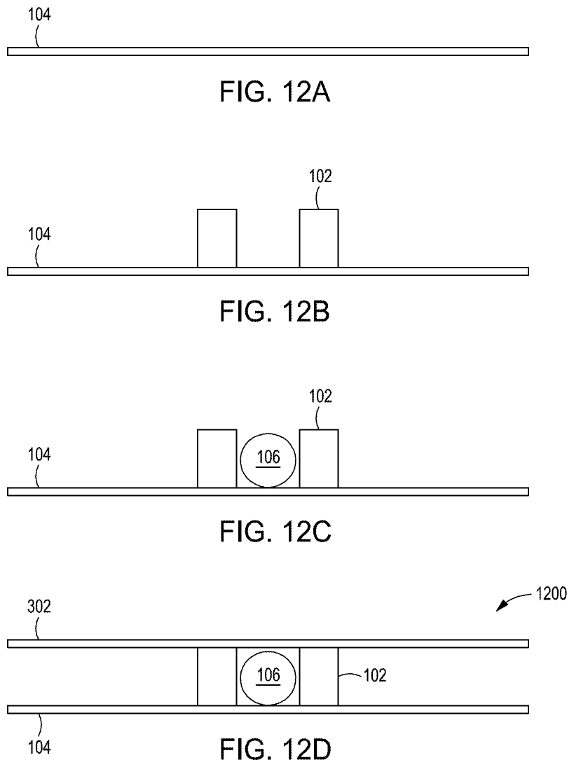

FIGS. 12A-12D show a method of forming a textile assembly 1200 in accordance with some embodiments of the present disclosure. In some embodiments, and as shown in FIG. 12A, a textile 104 may be provided. As shown in FIG. 12B, guides 102 are deposited or otherwise formed on the textile 104 as described above. In some embodiments, and as shown in FIG. 12C, an elongate element 106 is introduced between the guides 102. The elongate element 106 has a height that is equal to or less than the height of the guides 102. As shown in FIG. 12D, a textile layer 302 is connected to the tops of the guides 102 forming the textile assembly 1200. In some embodiments, and as shown in FIG. 12D, the layers of textiles 104 and 302 are not directly bonded to one another adjacent to the guides 102. The method shown in FIGS. 12A-12D has the benefit of textile texture on both sides, making it useful for application where skin contact or a hidden technology aesthetic is preferred.

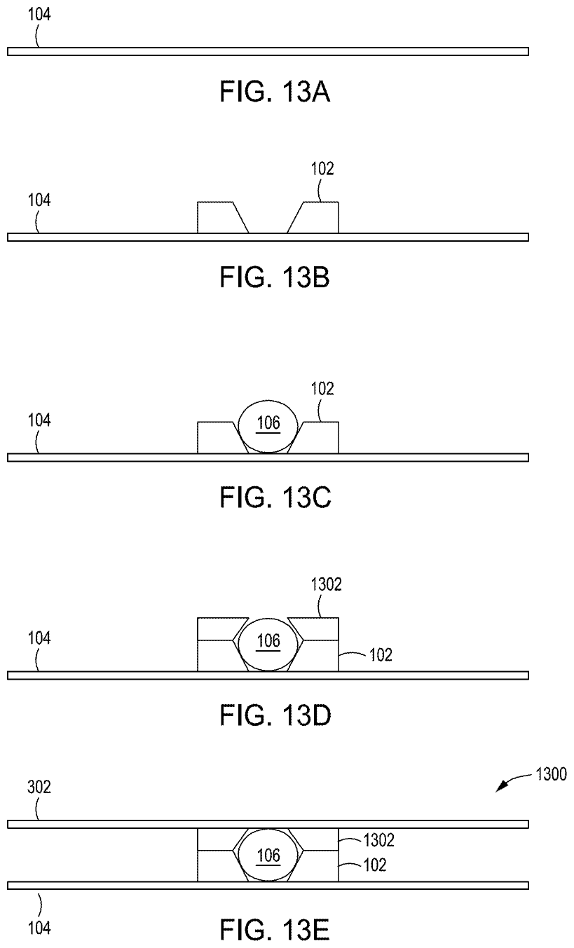

FIGS. 13A-13E show a method of forming a textile assembly 1300 in accordance with some embodiments of the present disclosure. In some embodiments, and as shown in FIG. 13A, a textile 104 may be provided. As shown in FIG. 13B, guides 102 are deposited or otherwise formed on the textile layer 104 as described above. In some embodiments, and as shown in FIG. 13C, an elongate element 106 is introduced between the guides 102. As shown in FIG. 13D, a guide 1302 may be deposited onto a top of the guides 102. As shown in FIG. 13E, a textile layer 302 is attached to top of the guides 1302. The method shown in FIGS. 13A-13E illustrates how multistep polymer deposition can be leveraged with dissimilar or like materials. Custom profiles can be created with paired routing to influence performance attributes.

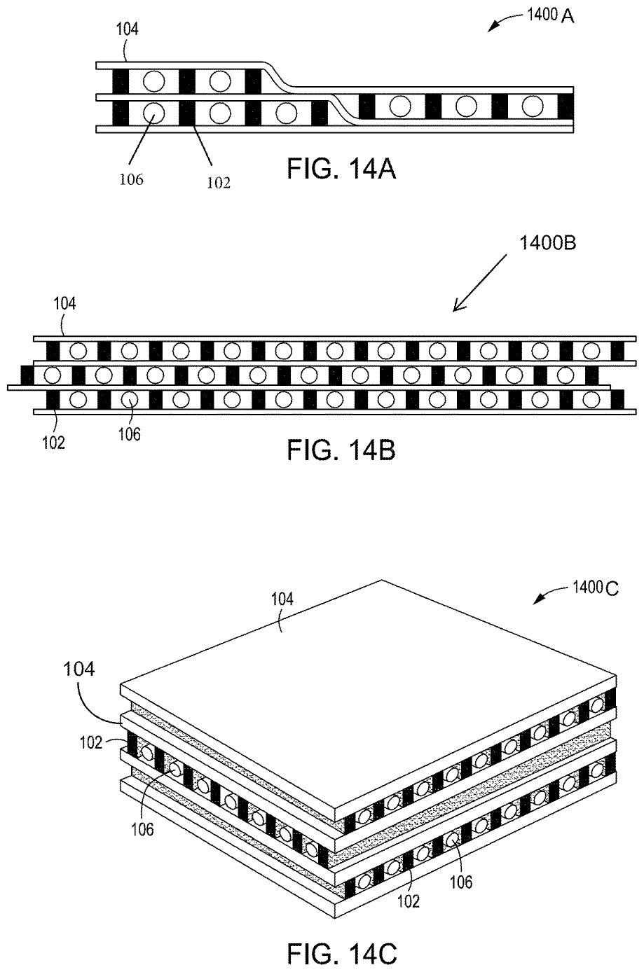

FIGS. 14A-14C show textile assemblies 1400A-1400C in accordance with some embodiment of the present disclosure. In some embodiments, textile assemblies 1200 described above may be stacked to provide a multi-level construction. In some embodiments, and as shown in FIGS. 14A-14C, the textile assemblies 1400A-1400C may include a plurality of textiles 104 bonded to guides 102 between the textiles 104. The textiles 104 used at each level of the textile assemblies 1400A-1400C may be the same or may differ for various functional reasons. For example, in some embodiments, specialty textiles can be embedded at certain levels of the textile assemblies 1400A-1400C to provide shielding or ground planes to improve electronics performance. In some embodiments, elongate elements 106 (e.g., hollow tubes) may be positioned between textiles 104 and between guides 102 in order to form the textile assemblies 1400A-1400C as reinforced inflatable components. In some embodiments, and as shown in FIG. 14C, each level of the textile assembly 1400C may be stacked with the elongate elements 106 alternating in direction (e.g., by 90 degrees in FIG. 14C).

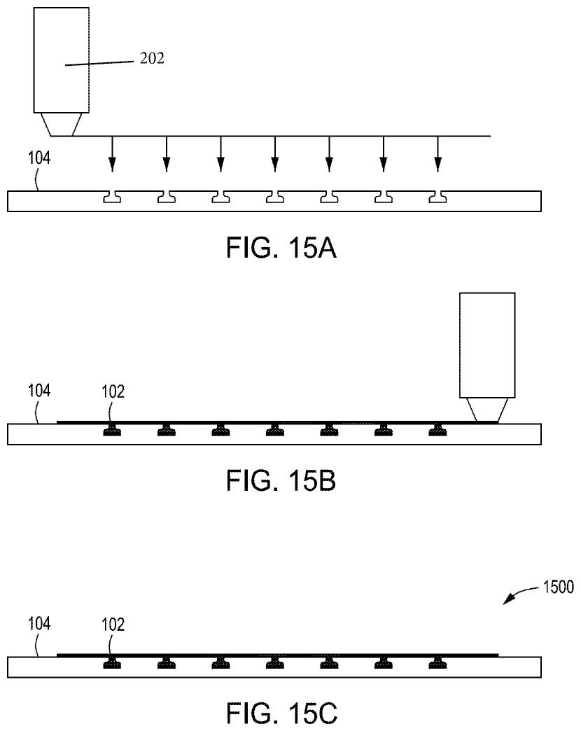

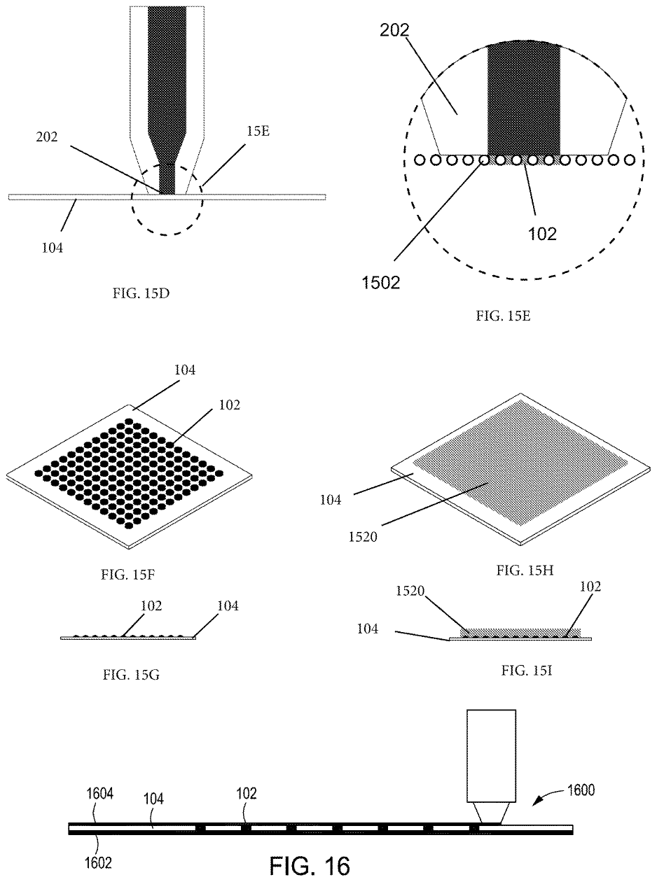

FIGS. 15A-15C show a method of forming a textile assembly 1500 in accordance with some embodiments of the disclosure. In some embodiments, and as shown in FIG. 15A, a 3D mesh textile 104 for 3D printing may be provided with textile structures that form a mesh surface on the face of the textile 104. The arrows shown in FIG. 15A are along a machine path where the nozzle 202 may press tightly against the face of the textile 104 at regular (e.g., spaced) intervals. In FIG. 15B, a liquid polymer is 3D printed on the textile 104. The temperature of the liquid polymer may be increased to at least one of reduce viscosity, improve flow, or improve polymer penetration of the liquid polymer into the textile. FIG. 15C shows a resulting composite textile assembly 1500 having a structure with improved mechanical bonding through textile features interlocking with the polymer. The method shown in FIGS. 15A-15C may be used on textiles without apparent texture or mesh features, such as jersey knit, nonwoven, plain weave, or twill fabric where the yarns are tightly bound.

FIGS. 15D-15I show a method of forming a textile assembly in accordance with some embodiments of the present disclosure. In some embodiments, and as shown in FIGS. 15D, 15F, and 15G, an array of dots 102 may be placed or otherwise deposited (e.g., by 3D printing) onto a textile 104. The dots 102 may provide improved bonding performance and may later be covered by other features or structures 1520 as shown, for example, in FIGS. 15H and 15I. In some embodiments, and as shown in FIG. 15E, the nozzle 202 of the 3D printer may be dipped into the textile 104 while dispensing liquid polymer. The nozzle 202 may be pressurized to increase resin pressure in the nozzle 202 forcing deeper polymer penetration into open gaps of the textile 104, between yarns or fibers 1502 of the textile 104, or entangle the textile 104 at a fiber level, thereby increasing mechanical bonding between the liquid polymer and the textile 104.

FIG. 16 shows a method of forming a textile assembly 1600 in accordance with some embodiments of the present disclosure. In some embodiments, and as shown in FIG. 16, a layer, such as a base print layer 1602 (may also be a TPU film or molded part), may be deposited by a 3D printer before laying a textile 104 onto the base print layer 1602. Then, polymer may be dispensed through the textile layer 104 as described above in the method of forming textile assembly 1500 followed by a deposition of an upper print layer 1604. The base print layer 1602 and the upper print layer 1604 are bonded together with the polymer within the textile 104 thereby mechanically linking the polymer to the textile 104. The textile assembly 1600 can provide a strong bonding between the polymer and the textile layer by enhancing the mechanical bonds through backside geometry. Depositing a base print layer where delamination may be a problem before laying the textile onto the print bed allows for the polymer deposition on top to bond to the base print.

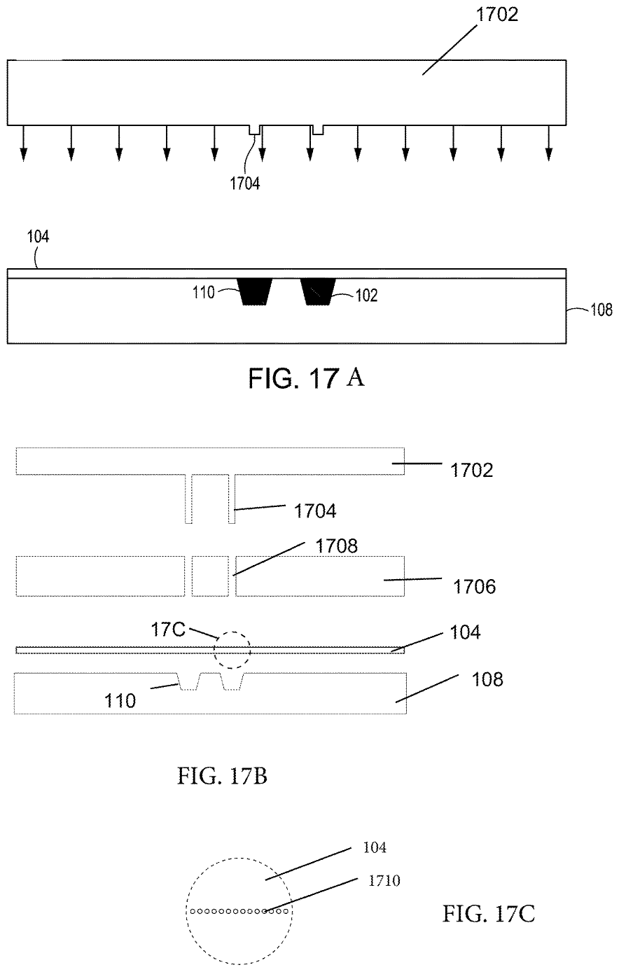

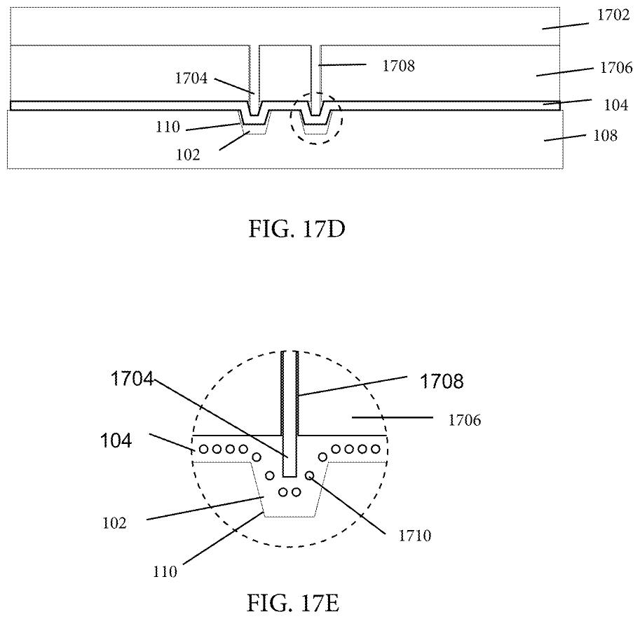

FIG. 17A shows a method of forming a textile assembly in accordance with some embodiments of the present disclosure. In some embodiments, and as shown in FIG. 17A, a textile 104 and polymer guides are shown joined together in the same way as described and shown in FIG. 1C. A tool 1702 with backing probes 1704 vertically aligned with the grooves 110 may be pressed against the textile 104 to push the textile 104 mechanically into the liquid polymer as the guides 102 are being molded. The backing probes 1704 can be used to improve mechanical bonding between the textile 104 and the guides 102. For example, the backing probes 1704 may change the depth of the textile 104 in the guides 102 and also create more permeable openings between the fibers of the textile 104 for better ingress of polymer.

FIGS. 17B-17E show another method of forming a textile assembly in accordance with some embodiments of the present disclosure. In some embodiments, and as shown in FIG. 17B, the probes 1704 of the tool 1702 are longer than those shown in FIG. 17A and a probe guide 1706 with holes 1708 may be interposed between the tool 1702 and the mold 108. The probes 1704 may be configured to slide in the holes 1708, which may be aligned with the grooves 110. As shown in FIG. 17B, the textile 104 may be positioned between the guide 1706 and the mold 108. As shown in FIG. 17C, the textile 104 may include yarns 1710 which may be closely spaced (e.g., about 0.5 mm) in an unstretched configuration of the textile 104.

In some embodiments, and as shown in FIGS. 17D and 17E, liquid polymer 102 may be poured or otherwise deposited into the grooves 110 and the textile 104 may be placed in contact with the top of the mold 108 and in contact with the polymer 102. In some embodiments, the guide 1706 may be pressed onto the textile 104 along areas around the grooves 110 to first hold the textile 104 in place. Then, with the textile 104 held in place by the guide 1706, the probes 1704 may be pushed into the textile to locally stretch the textile 104 and spread the yarns 1710 apart, as shown in greater detail in FIG. 17E. Mechanical manipulation/spreading the yarns 1710 apart allows the polymer 102 to fill in spaces around the threads 1710 and encapsulate the threads 1710.

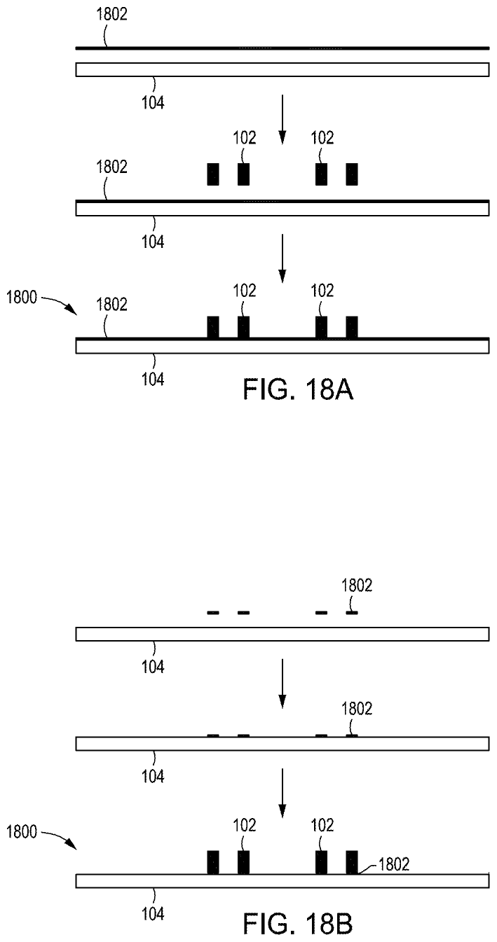

In some instances the material of the features 102 and the textile 104 may not achieve a desired bonding level due to incompatibility of materials or treatments on the textile 104. To address such incompatibility, in some embodiments, a method of forming a textile assembly 1800 may include bonding an intermediate material 1802 (e.g., a bonding film or primer material) as shown in FIGS. 18A and 18B between the features 102 and the textile 104. The intermediate material 1802 bonds the materials of the polymer guides 102 and the textile 104 to enhance performance of the resulting textile assembly. In some embodiments, and as shown in FIG. 18A, the intermediate material 1802 is bonded to the textile 104 prior to forming and bonding the polymer guides 102 to the textile 104. In FIG. 18A, the intermediate material 1802 may extend between multiple polymer guides 102. In FIG. 18B, the intermediate material 1802 may be selectively coated to extend only under the polymer guides 102. In some embodiments, the intermediate material 1802 may be deposited by various methods, including inkjet printing, 3D printing, CNC deposition, lamination, die cutting, and screen printing.

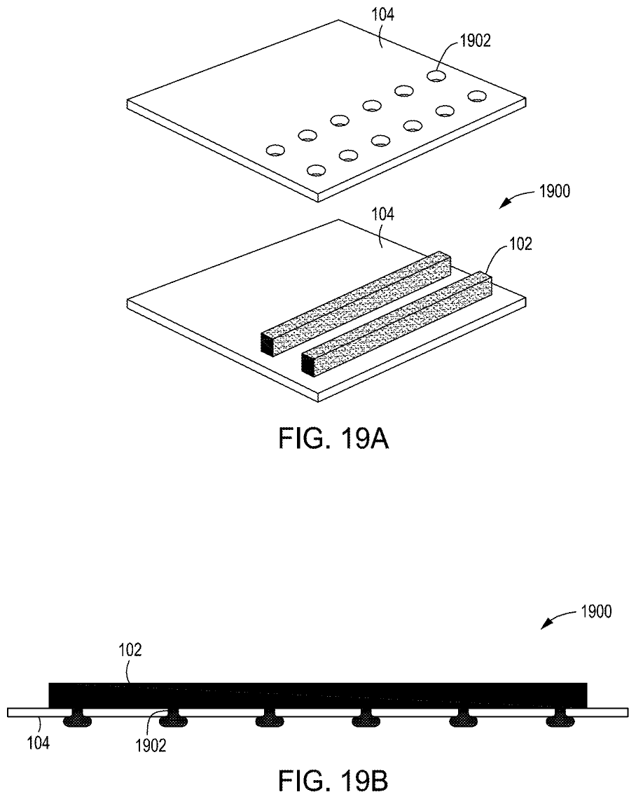

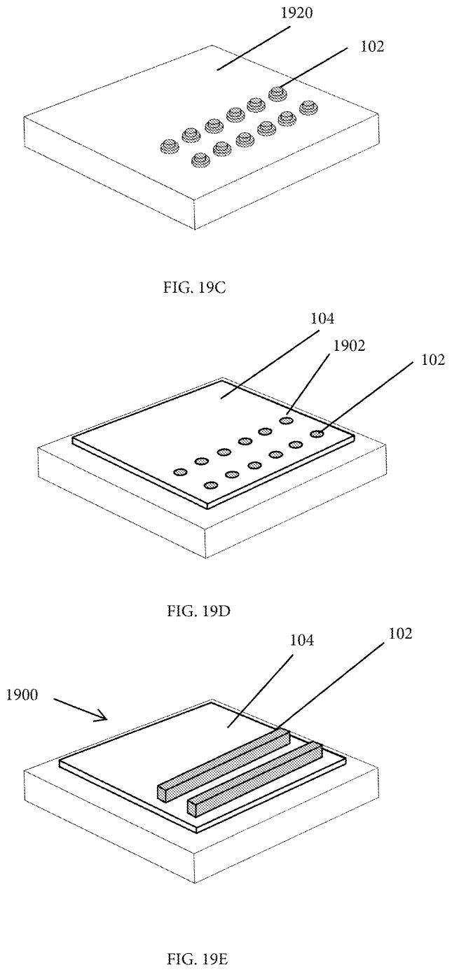

FIGS. 19A and 19B illustrate another embodiment of a textile assembly 1900 in accordance with some embodiments of the present disclosure. In some embodiments, and as shown in FIG. 19A, holes 1902 may be formed in a textile 104. The holes 1902 may be formed by laser cutting, die cutting or other methods for perforating the textile 104 before polymer deposition. A liquid or molten polymer may be deposited over and through the holes 1902, such as by 3D printing, along each row of holes 1902 forming polymer guides 102. As shown in FIG. 19B, the polymer guides 102 may extend through the holes 1902 and along a back side of the textile 104, thereby improving the mechanical integration of the polymer guides 102, and bonding and durability polymer is enhanced through polymer encapsulation from both side of the textile.

FIGS. 19C-19E illustrate another embodiment of forming the textile assembly 1902 in accordance with some embodiments of the present disclosure. The guides 102 of the textile assembly 1902 are interlocked with the holes 1902 of the textile. In some embodiments, and as shown in FIG. 19C, liquid polymer features 102 (e.g., pegs) may be formed in a pattern on a platform 1920. In some embodiments, the platform 1920 may be a bed of a 3D printer and the liquid polymer features 102 may be formed by 3D printing. In some embodiments, and as shown in FIG. 19D, a textile 104 has holes 1902 arranged in a pattern matching the pattern of the pegs 102 on the platform 1920. The textile 104 may be placed onto the guides 102 so that the pegs 102 align with the holes 1902 on a bottom side of the textile 104. In some embodiments, and as shown in FIG. 19E, additional polymer may be deposited through the holes 1902 from the top of the textile 104 to bond to each peg 102 on the bottom of the textile 104 and creating mechanical encapsulation of the textile 104. As shown in FIG. 19E, additional polymer can be deposited (e.g., by 3D printing) along the top side of the textile 104 to form elongated guides 102 shown in FIG. 19E connecting multiple polymer pegs that are on the bottom side of the textile 104. The methods shown in FIGS. 19C-19E and described herein provide a dual benefit of mechanical locking as well as improving manufacturability by providing textile fixturing.

### Use Examples

### Lighting

The embodiments of textile assemblies described herein may be used to integrate lighting components with the textile assemblies. Integrating LED lighting, for example, into a textile assembly may open up numerous display and user feedback opportunities. In some embodiments, guides 102 may be used to encapsulate lighting components and to control how light is cast from the lighting. That is, in some embodiments, light diffusion through a textile can be controlled by adjusting the shape profile of the one or more guides 102 as described below. Furthermore, textiles 104, 302 (or films) with varying transparency, translucency, or opacity can be used to influence the visual effect of the assembly.

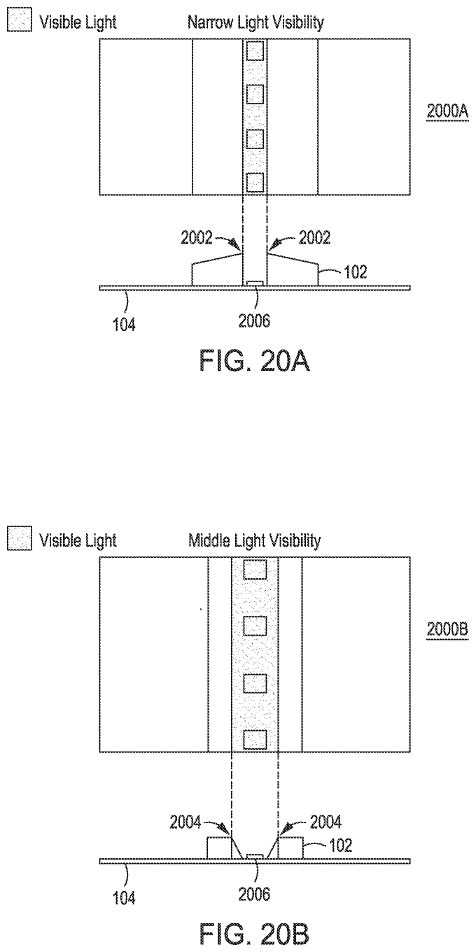

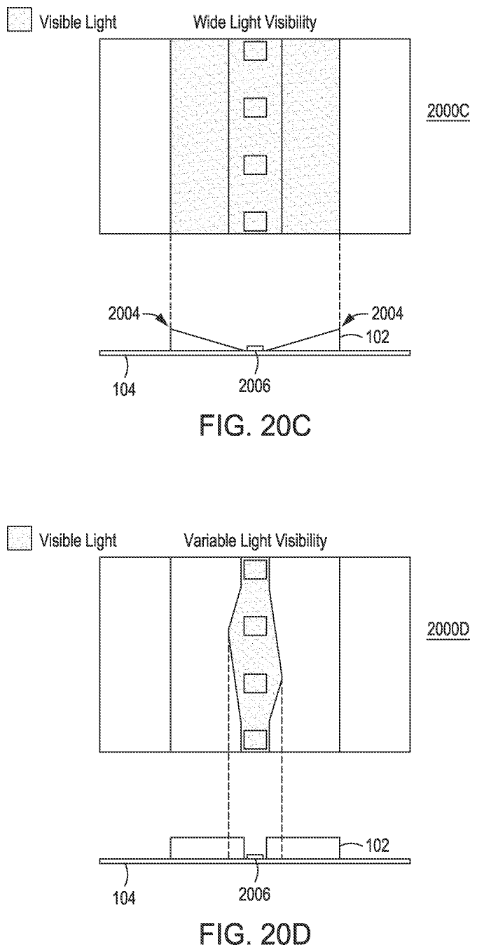

FIGS. 20A-20D show textile assemblies 2000A-2000D that incorporate lighting features in accordance with some embodiments of the present disclosure. The textile assembly 2000A is constructed similarly to the textile assembly 100 shown in FIG. 1D except that the elongate element 106 includes a strip of LEDs 2006 between the guides 102 giving the appearance of a constant bar of light and reducing the point of light typically given by individual LEDs. If the LED were different colors, the colors would blend in the zone between the LEDs. The guides 102 in the textile assemblies 2000A-2000D may define the limit width of diffusion of the light, which can, in some embodiments, be controlled dynamically based on the dimensions of the guide 102. In the textile assembly 2000A, the guides 102 are tapered outwardly away from the LED so that the light visibility extends between the inner tapered edges 2002. The guides 102 of the textile assembly 2000B and 2000C shown in FIGS. 20B and 20C are tapered inwardly toward the LED allowing the light to spread between the outer tapered edges 2004. In the textile assembly 2000D, the guides 102 are not tapered, but are flat along their upper ends. As shown in FIG. 20D, the width between the guides 102 of the textile assembly 2000D define a limit width of diffusion of light that varies along a length of the strip of the LEDs.

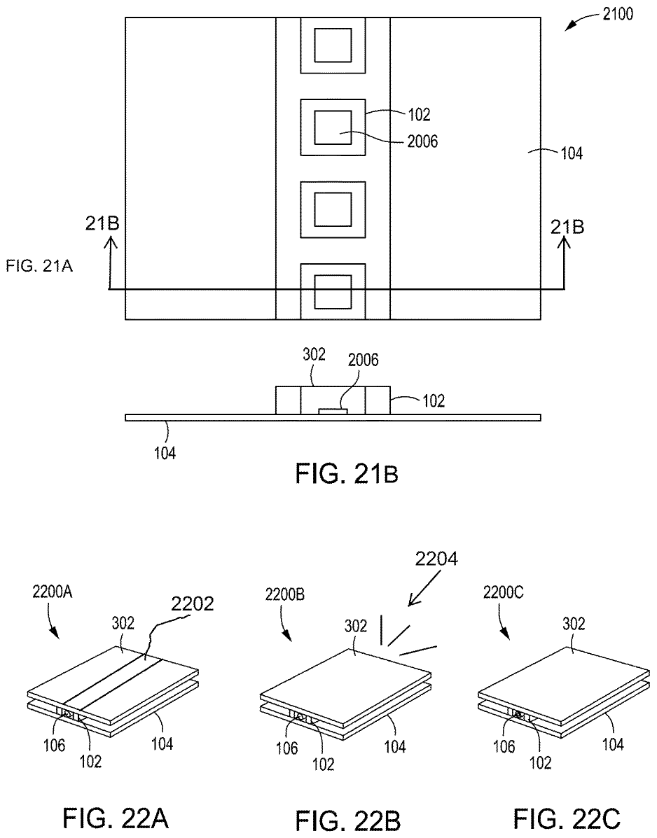

In addition to or alternative to a blended LED strip of the textile assemblies 2000A-2000C, each LED 2006 could also be encapsulated individually by the guide 102, giving each LED a confined diffusion zone when illuminated. This may be accomplished using a square guide geometry or used in more complex shapes, as shown in FIG. 21. For example, a textile assembly 2100 may be formed like the assembly shown in FIG. 4C, with the guide 102 formed in a square and an LED disposed in the cavity 105 and covered by a translucent textile layer 302.

FIGS. 22A and 22B show textile assemblies 2200A and 2200B in accordance with some embodiments of the disclosure. In some embodiments, the textile assemblies 2200A and 2200B may include elongate elements 106 that are fiber optic cables. The textile assembly 2200A is constructed like the textile assembly 1200 described herein, where the elongate element 106 is a fiber optic cable using side or edge-glow fiber optics and the textile layer 302 may be formed partially or fully from a transparent material so that light from the fiber optic cable can diffuse through the textile layer 302 at least along a portion of the textile layer 302. The textile assembly 2200B may also be constructed like the textile assembly 1200 described herein, where the elongate element 106 is an edge glow fiber optic cable so that light 2204 diffuses from the end of the cable as shown in FIG. 22B. In some embodiments, and a shown in FIG. 2200C, the textile assembly is constructed like the textile assembly 1200, but where the elongate element 106 is a fiber optic cable used for data or sensing applications.

### Pneumatics & Hydraulics

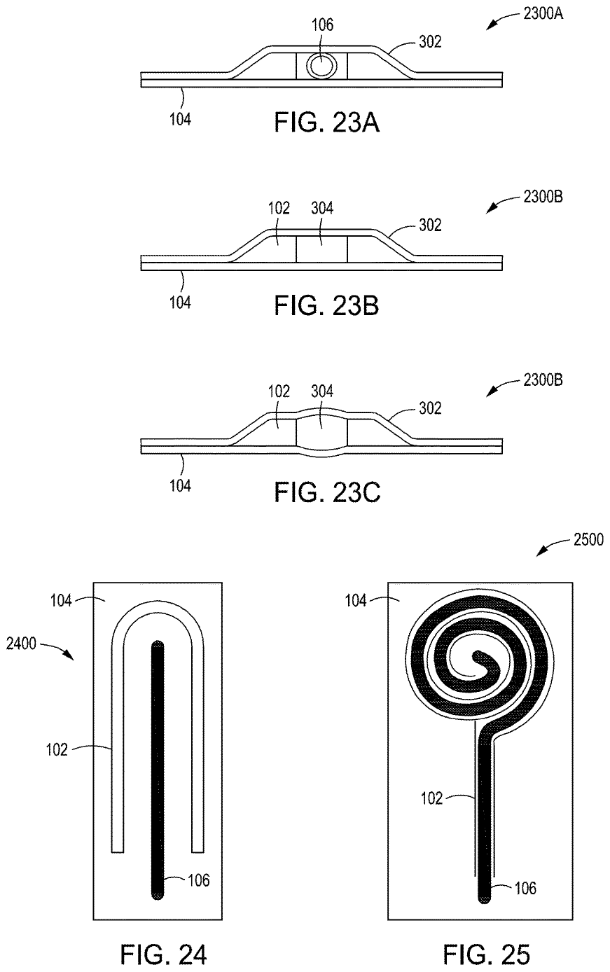

FIGS. 23A-23C show textile assemblies 2300A and 2300B integrating fluid routing pathways leveraging the guide structure itself or embedding tubes to integrate pneumatic or hydraulic features into a textile. The textile assembly 2300A may be constructed like the textile assembly shown in FIG. 10B where the elongate element 106 is a tube that can be for carrying a fluid (e.g., liquid or gas). Also, in FIGS. 23B and 23C, the textile assembly 2300B may have the same features as the textile assembly 2300A, but with the omission of the tube 106. In the textile assembly 2300B, the textile layers 104 and 302 may be sealed to the guides 102 so that the space 304 is a sealed channel which may be inflated. In some embodiments, the tube 106 or the textiles 104 and 302 may be relatively flexible to be elastic or rigid to resist compressions. In some embodiments, rigidity may be useful for transferring pressure between zones of the textile 104. In the embodiment of the textile assembly 2300B shown in FIG. 23C, the textile layers 302 and 104 may be flexible and elastic so that the space 304 may expand when inflated, as shown in FIG. 23C. In some embodiments, elasticity may be an advantage for sensing or actuation.

FIG. 24 shows an embodiment of a textile assembly 2400 used for pneumatic pressure sensing. The textile assembly includes a textile 104, a guide 102 connected to the textile 104 that extends in an elongated U-shape, and an elongate element 106 (e.g., a tube) containing a fluid (liquid or gas). The elongate element 106 may be a compressible tube. The elongate element 106 may be located at a point of sensing pressure, such as along a finger sleeve of a glove. The elongate element may be fluidly coupled to a remote pressure sensor electronics that are configured for measuring pressure of the fluid in the elongate element 106. Compressing the outside of the tube may cause fluid inside the tube to compress. Any pressure change of fluid can be transferred away from the point of sensing to the remote sensor electronics.

FIG. 25 shows an embodiment of a textile assembly 2500 in which the polymer guide 102 and the elongate element 106 of the textile assembly 2400 are coiled into a spiral. The spiral forms an area fill geometry to receive pressure at a specific area or zone on the textile 104.

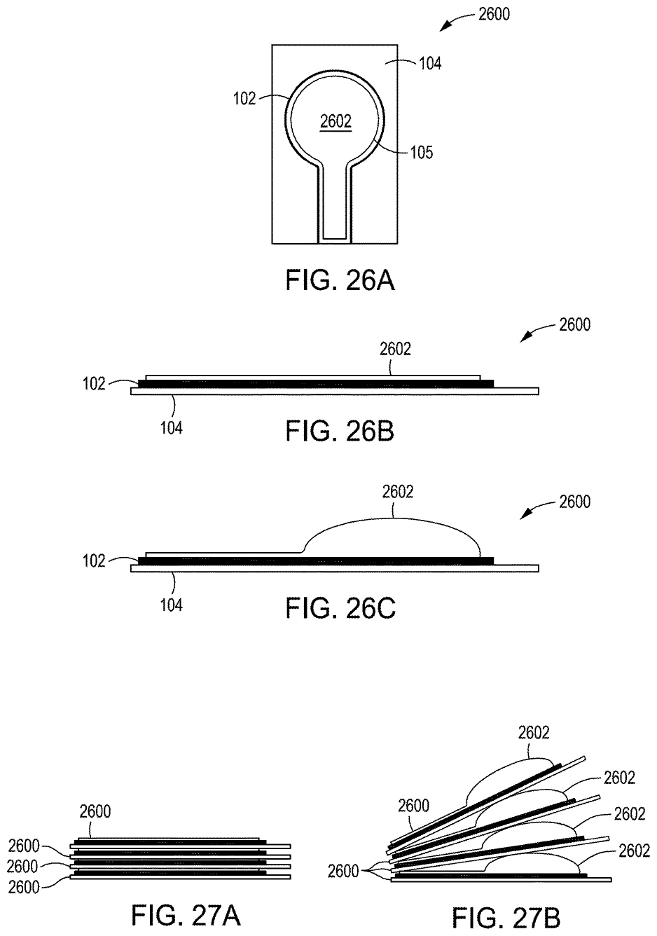

FIG. 26A-26C show a textile assembly 2600 in accordance with some embodiments of the present disclosure. As shown in FIGS. 26A-26C, the textile assembly 2600 may include a textile 104, a guide 102 attached to the textile 104, and a cavity 105 formed in the guide 102. In some embodiments, a bladder 2602 may be inserted in the cavity 105. In some embodiments, the bladder 2602 may be formed in cavity 105 by bonding of an additional textile layer (e.g., 104, 302) over the cavity. In some embodiments, a textile layer 302 may cover the bladder 2602 and may be bonded to at least one of the bladder 2602, the guide 102, or the textile 104. The bladder 2602 may be connected to a fluid supply (e.g., air) to selectively inflate or deflate the bladder 2602. FIG. 26B shows the textile assembly 2600 with the bladder in a deflated state and FIG. 26C shows the textile assembly in an inflated state.

FIGS. 27A and 27B shows a stack of textile assemblies 2600. In FIG. 27A, the bladders 2602 are deflated and in FIG. 27B the bladders 2602 are inflated causing a rotated articulation of the textile assemblies 2600. Through the creation or insertion of inflatable bladders 2602, actuation zones can be created in textiles. Using multiple inflatable bladders together can create complex and reliable articulation. In some embodiments, the stack of textile assemblies 2600 create an actuator with increased actuation distance or angle.

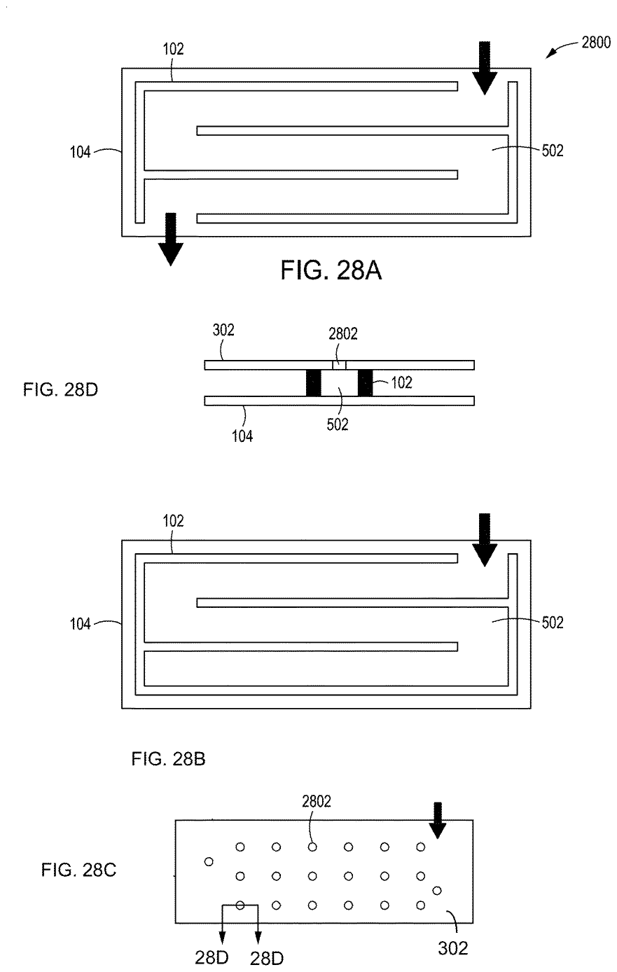

FIG. 28A shows a textile assembly 2800 in accordance with some embodiments of the present disclosure. The textile assembly 2800 may be formed in the same manner as the textile assembly shown in FIG. 5A. However, instead of routing an elongate element 106 through the routing pathway 502, the pathway 502 may be used for routing a moving fluid, such as a heated or cooled fluid. In some embodiments, the pathway 502 may include gas or liquid and may be used for heating and/or cooling applications as well as for heat dissipation or radiators. The shape and location of the routing pathway 502 can influence the surface area exposed to the fluid and can tune the energy output.

FIG. 28B shows an alternate textile assembly to that shown in FIG. 28A with the exception that an outlet is omitted. In some embodiments, such as shown in FIGS. 28C and 28D, holes 2802 may be located in a top textile layer 302 covering the guides 102. The holes 2802 may be aligned with the routing pathway 502 and act as exits for fluid. Thus, the routing pathway is perforated with one or more holes 2802 to enable selective distribution of the heated or cooled liquid. In cooling applications, the holes 2802 can enhance evaporative cooling. The guides 102 and pathway 502 of the textile assembly 2800 can be used to regulate and control/tune airflow.

### Articulation

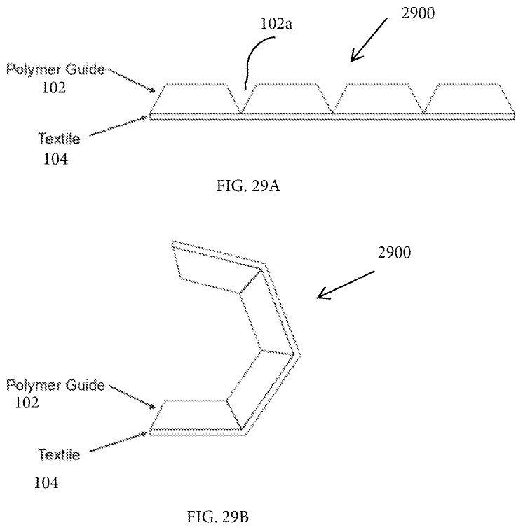

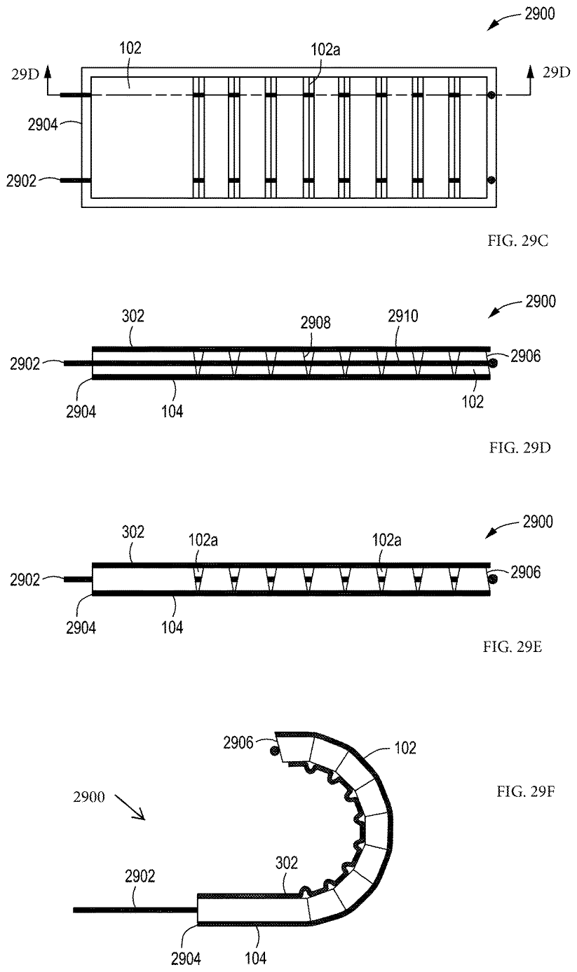

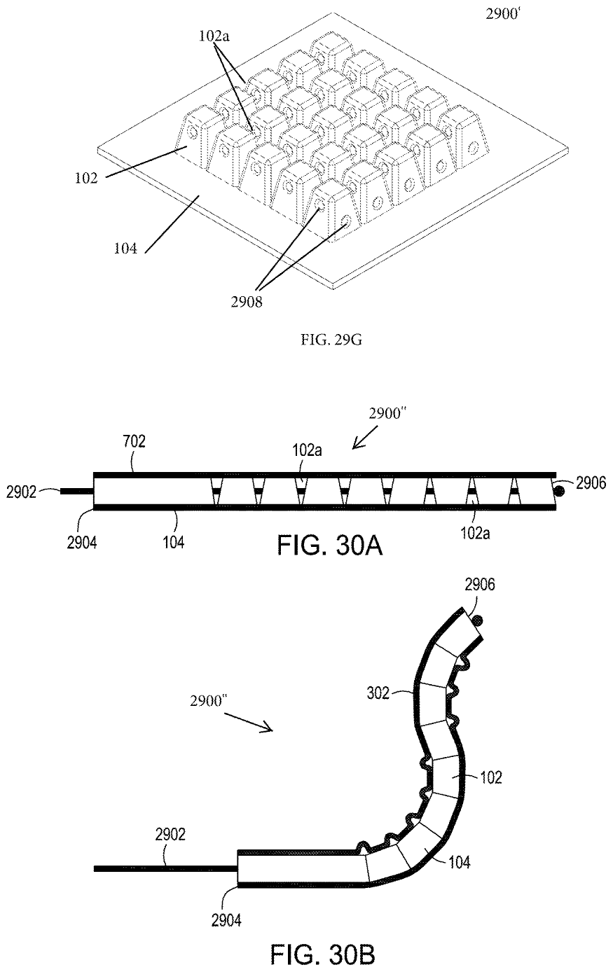

FIGS. 29A-29B show another textile assembly 2900 in accordance with some embodiments of the present disclosure. The textile assembly 2900 may be configured for articulation. The textile assembly 2900 may include an elongated flexible polymer guide 102 having segmented notches 102a (e.g., shown a tapered notches) that allow the polymer guide to articulate or flex, as shown in FIG. 29B. The angle of the notches can provide a physical stop or flexion lockout to limit the range of articulation of the textile assembly 2900, as shown for example, in FIG. 29B. Flexion lockout features can tune the mechanical performance of the textile assembly 2900. Defined geometry can allow for high flexibility in many stages and then “lock out” or limit articulation at a predefined geometric limit defined by the notches 102a.

FIGS. 29C-29F show the textile assembly 2900 modified for articulation with a cable 2902. In some embodiments, and as shown in FIGS. 29C-29F, the polymer guide 102 may be attached to a textile 104 along a bottom side of the polymer guide 102 and may be attached to another textile layer 302 along a top side of the polymer guide 102. One or more cable pathways 2908 may be formed through the polymer guide 102 and through the segmented notches 102a. In FIG. 29D, a cable pathway 2908 is formed from a first end 2904 to a second end 2906 of the polymer guide 102. Integrated low friction-tubes 2910 or low-friction polymers can be inserted into the cable pathways 2908 to allow tensile cables 2902 to be inserted through specialized actuation geometry to create fully articulated textile structures. The cable 2902 may be knotted or otherwise stopped at the second end 2906. Pulling the cable 2902 away from the first end 2904 of the polymer guide 102 in FIG. 29E causes the textile assembly 2900 to assume the rolled configuration shown in FIG. 29F. As shown in FIG. 29E, the textile assembly 2900 has flexed to the point of flexion lockout due to the contact made between each polymer guide 102.

FIG. 29G shows a textile assembly 2900′, which is a modified version of the textile assembly 2900 shown in FIGS. 29C-29F in three dimensions and which can be used to create more complex multidimensional articulated surfaces along textile 104. As shown in FIG. 29G, the textile assembly 2900′includes multiple rows of polymer guides 102 bonded to textile 104. Notches 102a are present on all sides of each polymer guide 102 to allow for articulation in multiple directions. Each guide 102 may include cable pathways 2908 in multiple directions, such as orthogonal directions shown in FIG. 29G.

FIGS. 30A and 30B show a textile assembly 2900′ which is a further modification of the textile assembly 2900 in which the polymer guide 102 has segmented notches 102a in opposite directions that permit the textile assembly 2900′ to articulate in two directions forming an S-shape.

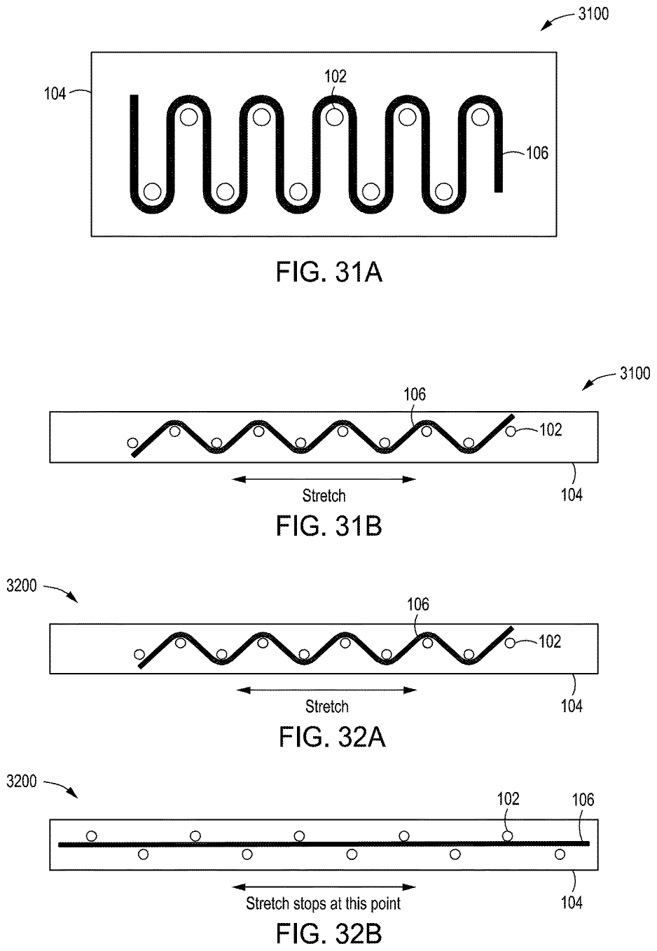

FIGS. 31A and 31B show a textile assembly 3100 in accordance with embodiments of the present disclosure. The textile assembly 3100 may be arranged like the textile assemblies 700A-700C with peg guides 102 and the elongate element 106 arranged in a serpentine or sinusoidal pattern, which can be used to introduce strain relief for applications where the material of the textile 104 could be sensitive to strain. In FIG. 31A, the inserted material and the material of the textile 104 are in an unextended state. In FIG. 31A, the material of the textile 104 is in a stretched configuration where the peg guides 102 are spread apart horizontally and moved vertically inwardly towards one another as tension is imparted to the elongate element 106.

FIGS. 32A and 32B show a textile assembly 3200 in accordance with embodiments of the present disclosure. The textile assembly 3200 may be arranged like the textile assemblies 700A-700C with peg guides 102 and the elongate element 106 arranged in a serpentine or sinusoidal pattern. The elongate element 106 may be formed of high-tenacity yarns or filaments, which can be used with the integrated guides 102 to limit the potential stretch of the textile 104 at a targeted, predefined distance, as shown in FIG. 32B.

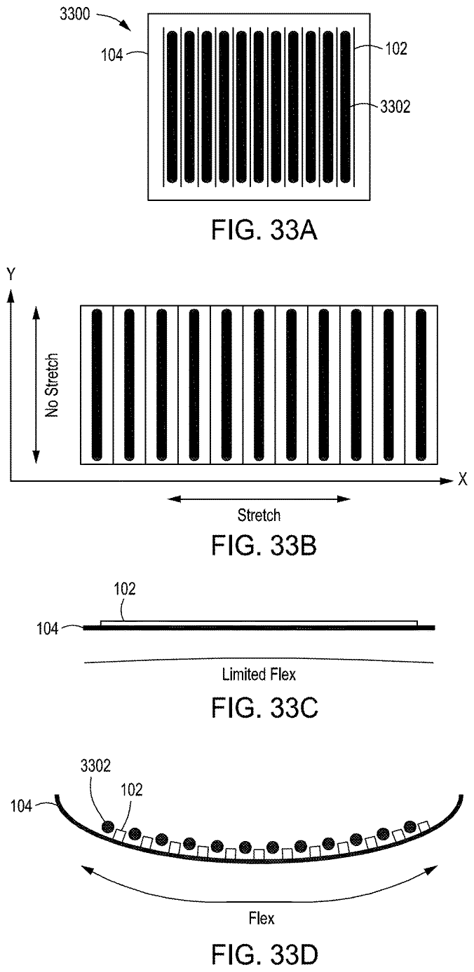

FIGS. 33A-33D show a textile assembly 3300 in accordance with embodiments of the present disclosure. The textile assembly includes a textile 104 with attached guides 102 and stiffening members 3302 inserted between guides 102. The stiffening members 3302 can be added via direct deposition casting or dropped in and retained by the guides 102. The stiffening members 3302 can be used to control deflection based on their geometry. The geometry can be linear integration shown in FIGS. 33A-33D or complex patterns that could provide anisotropic or tuned performance.

By way of example of anisotropy, as shown in FIG. 33B, due to the geometry of the stiffening members 3302, when the textile assembly 3300 is subject to a tensile load along the X and Y axes, there is no stretch along a Y-axis, while there is stretch along an X-axis. Also, as shown in FIG. 33D, when subject to the same bending moment about the X and Y axes, the textile assembly 3300 can flex about the X-axis while as shown in FIG. 33C, the textile assembly cannot flex about the Y-axis.

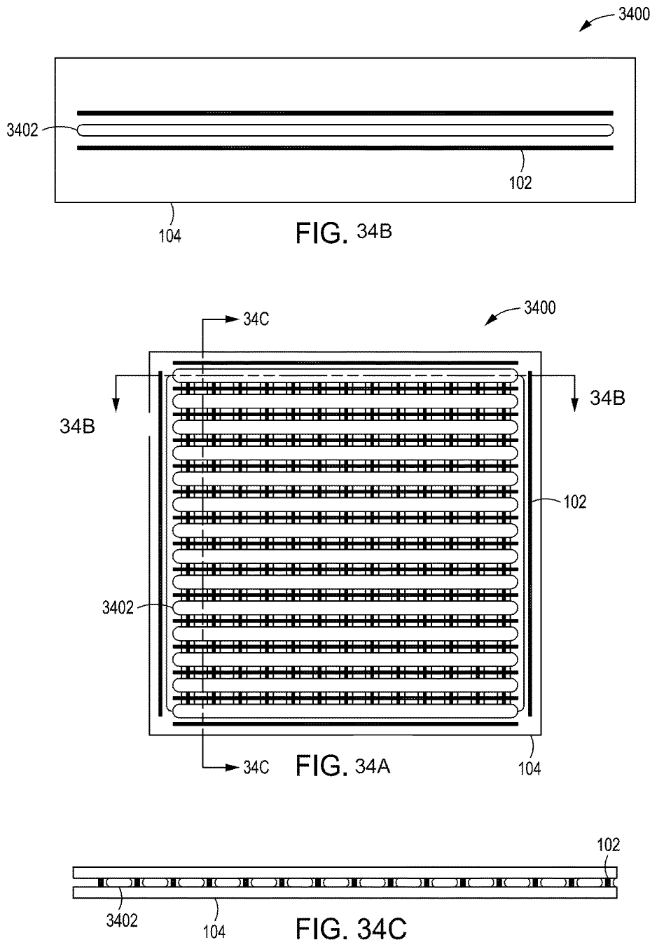

FIGS. 34A-34C show a textile assembly 3400 in accordance with some embodiments of the present disclosure. In some embodiments, and as shown in FIG. 34A, the textile assembly may include a textile 104, polymer guides 102 attached to the textile 104, and an elongate element 106, which is shown as a capacitive sensor 3402. The textile assembly 3400 may be used for proximity detection, swept capacitive sensing, or 2- or 3-dimensional sensing arrays. The use of a conductive textile assembly 3400 as may also allow for integrated ground planes to reduce signal noise. In FIG. 34A, the capacitive sensor 3402 is larger than that shown in FIG. 34A and is substantially surrounded by the polymer guides 102 on four sides of the capacitive sensor 3402.

### Electronic Sensor Integration

As described in connection with the embodiments shown in FIGS. 4A-4C, electronic sensor indicators and actuators can be embedded into the textile's layers. For example, sensor electronics may be disposed in cavity 105 shown in FIGS. 4B and 4C. Examples of components that may be integrated with textiles include, but are not limited to, FSRs, photoresistor, gas sensors, buttons, switches, accelerometers, magnetometers, gyros, temperature sensor, moisture sensors, galvanic skin sensors, time of flight, batteries, LEDs, motors, and electrodes.

### Multi-layer or Combined Systems

Due to the nature of the guide deposition and integration of the textile assembly, these systems can be used together to build unique systems that would be difficult or impossible to create through other methods.

1-26. (canceled)

27. A method of forming a textile assembly, the method comprising:
forming a first plurality of polymer features by disposing a first polymer on a first textile;
routing one or more elongate elements between the first plurality of polymer features; and
encapsulating the one or more elongate elements and at least some of the first plurality of polymer features with a second textile layer or a second polymer feature,
wherein the first plurality of polymer features is bonded to the first textile via mechanical bonding by textile features interlocking with the polymer disposed on the first textile.

28. The method of claim 27, wherein the first plurality of polymer features is bonded to the first textile through mechanical manipulation of the first textile to increase space between yarns that form the first textile to allow the polymer to penetrate further into the first textile.

29. A method of forming a textile assembly, the method comprising:
forming a first plurality of polymer features by disposing a first polymer on a first textile;
routing one or more elongate elements between the first plurality of polymer features; and
encapsulating the one or more elongate elements and at least some of the first plurality of polymer features with a second textile layer or a second polymer feature,
wherein forming the first plurality of polymer features includes depositing a liquid polymer onto the first textile by 3D printing.

30. The method of claim 29, wherein the first textile comprises a plurality of holes and wherein the holes are filled with liquid polymer by 3D printing.

31. The method of claim 27, wherein the one or more elongate elements is at least one of a cable, a tube, an electric wire, one or more lighting components, or a fiber optic cable.

32. The method of claim 27, wherein one or more elongate elements is one or more strips of LEDs, and wherein the first textile is translucent to allow light from the one or more strips of LEDs to be diffused through the first textile.

33. The method of claim 32, wherein light diffusion through the first textile is controlled by adjusting a shape profile of the one or more elongate elements.

34. The method of claim 27, wherein the first plurality of polymer features are segmented notches that create a pre-defined amount of articulation of the textile assembly.

35. A textile assembly comprising:
a first textile;
a first plurality of polymer features made from a first polymer disposed on the first textile;
one or more elongate elements routed between the first plurality of polymer features; and
a second textile layer or a second polymer feature that encapsulates the one or more elongate elements and at least some of the first plurality of polymer features,
wherein the first plurality of polymer features disposed on the first textile are at least one of segmented guides or grids of pegs to create custom routing paths.

36. A textile assembly comprising:
a first textile;
a first plurality of polymer features made from a first polymer disposed on the first textile;
one or more elongate elements routed between the first plurality of polymer features; and
a second textile layer or a second polymer feature that encapsulates the one or more elongate elements and at least some of the first plurality of polymer features,
wherein the size and shape of the first plurality of polymer features are tuned to modify a mechanical performance of the textile assembly, and
wherein the one or more elongate elements is a tube containing a gas or liquid, and wherein a pressure change or deformation of the tube can be measured.

37. A textile assembly comprising:
a first textile;
a first plurality of polymer features made from a first polymer disposed on the first textile;
one or more elongate elements routed between the first plurality of polymer features; and
a second textile layer or a second polymer feature that encapsulates the one or more elongate elements and at least some of the first plurality of polymer features,
wherein the first plurality of polymer features is bonded to the first textile via at least one of (A) mechanical bonding by textile features interlocking with the polymer disposed on the first textile, or (B) mechanical manipulation of the first textile to increase space between yarns that form the first textile.

38. The textile assembly of claim 35, wherein the one or more elongate elements is at least one of a cable, a tube, an electric wire, one or more lighting components, or a fiber optic cable.

39. The textile assembly of claim 35, wherein one or more elongate elements is one or more strips of LEDs, and wherein the first textile is translucent to allow light from the one or more strips of LEDs to be diffused through the first textile.

40. A textile assembly comprising:
a first textile;
a first plurality of polymer features made from a first polymer disposed on the first textile;
one or more elongate elements routed between the first plurality of polymer features; and
a second textile layer or a second polymer feature that encapsulates the one or more elongate elements and at least some of the first plurality of polymer features,
wherein the first plurality of polymer features are segmented notches that create a pre-defined amount of articulation of the textile assembly.
